(19) United States
(12) Patent Application Publication
(10) Pub. No.: US 2023/0071999 A1
(43) Pub. Date: Mar. 9, 2023

(54) SYNTHETIC EDIBLE MATERIAL WITH A PROTEIN CONCENTRATION GREATER THAN 50%

(71) Applicants: Matthew Inniger, Perrsyburg, OH (US); John Inniger, Murfreesboro, TN (US)

(72) Inventors: Matthew Inniger, Perrsyburg, OH (US); John Inniger, Murfreesboro, TN (US)

(21) Appl. No.: 17/467,646

(22) Filed: Sep. 7, 2021

(51) Int. Cl. A23J 3/22; A23J 3/26; A23J 3/16; A23J 3/04; A23L 15/00

(52) U.S. Cl. CPC A23J 3/225; A23J 3/26; A23J 3/16; A23J 3/04; A23L 15/00

(57) ABSTRACT

A synthetic edible proteinaceous material with a protein concentration of greater than 50% and the process for creating such proteinaceous material. The proteinaceous material is a substance comprising two materials: a denatured non-dairy protein isolate and a solid fat. By subjecting one or more of a variety of non-dairy isolated proteins to high-speed mixing, the protein denatures and can be mixed with a variety of solid fats to create a high-concentration protein colloid that is not only edible, but appetizing. The high-protein proteinaceous material can then be used as a standalone product or in various food supplements, including bars, baked goods, confections, or other edible products, particularly those for nutritional or medicinal purposes.

This is a Nonprovisional Patent Application for the invention of a “SYNTHETIC EDIBLE MATERIAL WITH A PROTEIN CONCENTRATION GREATER THAN 50%”.

### CROSS-REFERENCES TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING OR COMPUTER PROGRAM LISTING APPENDIX

Not applicable.

### BACKGROUND

### Field of the Invention

The present invention relates generally to protein foodstuffs and, more particularly, to high-protein foods having a limited number of optional ingredients and a wide variety of uses and the process for making such high-protein food.

### Description of the Related Art

For many years, and especially in the last few decades, the high-protein food industry has created an increasing number of new high-protein products guaranteeing higher percentages of protein by weight, better taste, and better combinability with other edible materials. Additionally, high-protein products are being implemented, prescribed, or suggested by medical and nutrition experts, trainers, coaches, and social media influencers, among many others, for an increased variety of applications, including weight loss and/or strength gain regimens, specialty diets, medical diets, nutritional diets, and lifestyle diets.

One problem the high-protein food industry has tried to solve is to create a product with a protein concentration greater than 50% by weight that is also usable for other applications and is not only edible but appetizing and pleasing to texture-sensing nerves of the mouth.

Typically, high-protein preparations and materials are derived from two different processes: 1) creating a suspension of isolated protein in a syrup-like binder; or 2) binding together high-protein solid particulates with a sugary coating. Neither of these processes can create an edible protein product with a protein concentration of greater than 50% by weight having a material consistency and texture that is pleasing to the mouth. These processes also fill the final high-protein food with other substances besides protein and fat, such as unhealthy or undesired sugars, salts, carbohydrates, and starches. Additionally, these processes often use dairy-based proteins, which not only limits the protein content of the high-protein food, but also may not be desirable for those consumers who either do not prefer or cannot have dairy-based proteins in their foods.

As to the first process for creating high-protein foods in the prior art, producers create a suspension of isolated protein in a liquid binder of some sort, either syrup, such as brown rice or corn syrup, or glycerin or other sugar alcohol, depending upon caloric and/or macronutrient goals. The protein concentration in these examples is limited by the suspension's physical properties, because as the protein concentration nears 50%, the material turns to an inedible, slightly damp pile of protein powder.

As to the second process for creating high-protein foods in the prior art, producers will bind together high-protein solid particulates such as nuts or extruded protein crisps, among other materials, with a compound coating or syrup binder. These methods result in protein foods filled with sugars, fibers, and salt, and the protein content in these foods is limited to less than 50% concentration by weight due to the lower natural protein content or the macronutrient density of the solid particulates.

Isolated protein powders can be used to create beverages with an exceptionally high protein content, even near 90% by weight. These protein products, though, are neither appetizing to the taste buds, pleasing to texture-sensing nerves of the mouth, nor of a consistency or texture suitable for eating, rather are intended to be dissolved in a liquid and consumed as a beverage.

What is lacking in the prior art is a protein material having greater than 50% by weight protein, has only one other ingredient, namely fat, does not contain dairy-based proteins, is edible, is appetizing, is pleasing to oral texture-sensing nerves, and is readily usable for a wide variety of applications.

### SUMMARY OF THE INVENTION

The present invention is directed to a synthetic edible proteinaceous material with a protein concentration of greater than 50% and the process for creating such proteinaceous material. The proteinaceous material is a substance composed of two materials: denatured non-dairy protein and solid fat. By subjecting one or more of a variety of non-dairy isolated proteins to high-speed mixing, the protein denatures and can be mixed with a variety of solid fats to create a high-concentration protein colloid that is not only edible, but appetizing. The proteinaceous material can then be used as a standalone product or in various foods, including bars, baked goods, and confections, or other edible products for nutritional or medicinal purposes.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, several terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. Additionally, the terms “synthetic edible material with a protein concentration greater than 50%”, and “proteinaceous material” are used interchangeably. The terminology herein is used to describe specific embodiments of the invention, but their usage does not delimit the invention, except as set forth in the claims.

The process for creating the proteinaceous material of the present invention starts with pre-whipping a selected solid fat using a high shear mixer, thereby entrapping air in the fat. The amount of fat used is dependent upon the final macronutrient ratio, which varies by the scale of application (i.e., commercial-scale production of the proteinaceous material, small-scale, etc.). The amount of fat introduced should not exceed 50% by weight of the final product in any case. The solid fat is placed in a high shear mixer and the high shear mixer is then turned on and increased at a rate of about 35 revolutions per minute (“RPM”) per second starting from 0 RPM until the fat is sufficiently incorporated with air. The fat is sufficiently incorporated with air when an increase in volume and a smooth, glossy finish on the fat is observed. This pre-whipping lowers the viscosity of the fat and increases the fat's surface area, thereby creating an edible structure prior to addition of an isolated protein source.

The process for creating the proteinaceous material uses a high shear mixer with an impeller head. The high shear mixer's minimum requirements concerning RPM and shearing force increases with the scale of application. Those skilled in the art will recognize that ribbon and paddle blenders are also used in the protein food industry, however, these blender types are not suitable for creating proteinaceous material of the instant process as they do not provide sufficient shearing force.

After about two minutes or longer (depending on the scale of application) of pre-whipping, a selected non-dairy isolated protein is added to the solid fat at a rate of less than or equal to about 0.5% of the final desired weight of protein in the proteinaceous material per second. Accordingly, the total amount of protein added is dependent on production scale and percentage of protein by weight desired in the finalized proteinaceous material. As the non-dairy isolated protein is added to the still-shearing fat, the protein denatures into a strand-like form, with a polar end and a nonpolar end. Persons of skill in the art will recognize that this shear-denaturing behavior is common in certain isolated proteins. As the shearing and mixing continues, the nonpolar ends of the denatured protein strands embed themselves into the micelles of the solid fat, as is most energetically favorable. At the same time, the shearing force on the solid fat particles causes additional air pockets to form in the solid fat and protein mixture, and the polar ends of the denatured non-dairy isolated protein strands embed themselves in those air pockets, as is most energetically favorable.

As the denatured protein strands' nonpolar ends insert into the micelles of the solid fat source and the polar ends insert into the air pockets, the effect is to connect the fat micelles to the air pockets in the protein and fat mixture. As a result, the fat micelles and air pockets have a higher surface area to volume ratio than the protein strands, such that the protein strands completely surround both the fat micelles and air pockets. The denatured protein thus occupies significantly less space in the mixture relative to the fat micelles, which allows for a much higher protein content to be achieved. The effect of this solid fat and non-dairy isolated protein ratio results in a material that is over 50% protein by weight. This process also gives the mixture its desired form, shape, and edibility characteristics.

Once the non-dairy isolated protein is fully mixed into the solid fat and immediately prior to the protein concentration exceeding the solid fat's breakpoint concentration, addition of the non-dairy isolated protein is ceased. In this process, a “breakpoint concentration” occurs at the point wherein the protein is fully mixed into the solid fat and air structure and does not exceed the capacity of the solid fat and air structure to hold the protein in suspension and create the desired proteinaceous material consistency. Exceeding the breakpoint concentration of the solid fat and air structure results in the weight of the material causing the structure to collapse, as the resulting material no longer has a sufficient amount of entrapped air to prevent such collapse. The resulting material maintains a high concentration of protein, but with the undesirable consistency of wet sand. Significant experimentation has established that for the instant process, the preferred breakout concentration for the fat and air structure wherein the isolated non-dairy protein is fully mixed into the solid fat and air structure but does not exceed the capability of the solid fat and air structure to hold the protein is about 60% to about 65% protein by weight. If the isolated non-dairy protein content is allowed to reach about 70% to about 75% protein by weight, the final product's texture is brittle as opposed to moldable, fluffy, firm, and pliant.

Adding the non-dairy isolated protein to the solid fat during high shear mixing at a rate greater than about 0.5% of the weight of protein desired in the finalized product per second may cause the high-speed mixer to fail to reach every micelle of solid fat, which results in a lower breakpoint concentration. A lower breakpoint concentration does not necessarily mean the final proteinaceous material will not fall within the desired protein concentration, be inedible, or not have the desired consistency; however, it does mean such material will be more prone to any one or more of these less-desirable traits.

The proteinaceous material is finalized when the total weight of the proteinaceous material equals the initial weight of solid fat prior to whipping plus the desired weight of protein (e.g., greater than 50% protein by weight); once this occurs, the high shear mixer is turned off and, after the high shear mixer comes to a standstill, the finalized proteinaceous material is removed from the high shear mixer in preparation for its ultimate use in commercial applications. The end product is a firm, fluffy, pliable, moldable, and edible material composed of solid fat and protein, with the concentration of protein exceeding 50% of the proteinaceous material by weight.

The protein-portion of the proteinaceous material is derived from proteins that denature under shear stress, namely non-dairy isolated proteins. Preferred shear stress-denaturing protein sources include non-dairy isolated proteins such as egg albumin, pea protein isolate, soy protein isolate, and beef protein isolate. Whey and casein protein and other dairy-based proteins do not form bipolar strands when denatured and cannot be denatured by shear stress, which negates their use for the proteinaceous material process of the present invention.

The fat-portion of the proteinaceous material is derived from mixing solid fats with the denatured non-dairy isolated proteins. Sources of solid fat that can be used to create the proteinaceous material include butter, margarine, soybean shortening, or hydrogenated olive oil, but for taste, the preferred source of solid fat is palm shortening.

The preferred final proteinaceous material ratio of protein to fat is protein greater than 50% by weight and fat less than 50% by weight.

The preferred consistency of the proteinaceous material presents in a form of a moldable, fluffy, firm, and pliant material.

The instant process and resulting proteinaceous material differ significantly from relevant processes and high-protein materials found in the prior art. Those skilled in the arts of high-protein preparations and materials will know of two main processes of creating high-protein concentration supplements and foods: 1) creating a suspension of isolated protein in a syrup-like binder; or 2) binding together high-protein solid particulates with a sugary coating. Neither of these processes can result in a synthetic, edible material with a protein concentration of greater than 50%.

As to the first process above for creating high-protein foods in the prior art, the protein concentration in the final product is limited by the suspension's physical properties, because as the protein concentration nears 50%, the material turns to an inedible, slightly damp pile of protein powder. In contrast, the present invention maintains its edibility characteristics, its firm but pliable form and structure, and its pleasant texture even at protein-by-weight percentages of greater than 50%.

As to the second process above for creating high-protein foods in the prior art, the final product is filled with sugars, fibers, and salt, and these protein materials do not have the same protein structure as that illustrated in the present invention and process. Additionally, the protein content in these foods is limited to less than 50% concentration by weight due to the lower natural protein content of the solid particulates or by the extrusion process used to create the protein content in the end product. In contrast, the present invention contains no sugars, fibers, salt, or dairy-based proteins, and is not limited to a concentration of less than 50% protein by weight.

An unexpected and surprising finding in the present invention and process for creating the proteinaceous material is that the ingredients as incorporated in the instant invention and process were not considered by those skilled in the art as effective at delivering an edible proteinaceous material having greater than 50% protein by weight while also having pleasing texture and taste and useful moldability and pliability characteristics. After significant experimentation, the instant useful invention was successfully created with such ingredients via a process not heretofore known nor contemplated by those skilled in the art.

An additional unexpected and surprising finding is that the instant invention is stable over time due to the exceptional performance of the denatured protein at stabilizing the fat and air structure. Those skilled in the art would expect that over time material such as that in the instant invention would degrade in a short amount of time (i.e., minutes, if not seconds) by losing its firmness due to the insolubility of air in non-polar materials, especially at atmospheric pressure. However, after significant experimentation, the instant invention has been found to be capable of overcoming these difficulties experienced by others in the industry and those skilled in the art, both sustaining an extremely high protein percentage by weight and maintaining its structure and firmness using the ingredients contemplated herein for an amount of time that will far exceed that necessary for use as a high-protein foodstuff.

The written description uses examples to disclose the invention and to enable any person skilled in the art to practice the invention, including making and using any materials or processes and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as a limitation of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or processes disclosed and claimed herein may be made and/or executed without undue experimentation in light of the present disclosure. While the compositions and processes of this invention have been described in terms of the embodiments included herein, it will be apparent to those of ordinary skill in the art that variations may be applied to the compositions and/or processes and in the steps or in the sequence of steps of the processes described herein without departing form the concept, spirit, and scope of the invention. All such similar substitutes and modifications apparent to those skilled in the art are deemed to be within the spirit, scope, and concept of the invention as defined by the claims.

Thus, although there have been described particular embodiments of the present invention of a new and useful SYNTHETIC EDIBLE MATERIAL WITH A PROTEIN CONCENTRATION GREATER THAN 50%, it is not intended that such references be construed as limitations upon the scope of this invention except as set forth in the claims.

We claim:

1. An edible proteinaceous material comprising:
a. a denatured isolated protein, wherein the denatured isolated protein has a greater than 50% by weight concentration based on the total weight of the proteinaceous material; and
b. a solid fat.

2. The proteinaceous material of claim 1, wherein the denatured isolated protein is denatured by shear stress mixing using a high shear mixer employing an impeller-type head attachment.

3. The proteinaceous material of claim 1, wherein the denatured isolated protein is a denatured non-dairy isolated protein.

4. The proteinaceous material of claim 3, wherein the denatured non-dairy isolated protein is egg albumin, pea protein isolate, soy protein isolate, or beef protein isolate.

5. The proteinaceous material of claim 4, wherein the solid fat is palm shortening, butter, margarine, soybean shortening, or hydrogenated olive oil.

6. The proteinaceous material of claim 3, wherein the proteinaceous material is greater than 50% but less than or equal to about 75% protein by weight.

7. The proteinaceous material of claim 3, wherein the proteinaceous material is greater than 50% but less than or equal to about 65% protein by weight.

8. The proteinaceous material of claim 3, wherein the proteinaceous material is about 60% to about 65% protein by weight.

9. The proteinaceous material of claim 4, wherein the proteinaceous material is about 60% to about 65% protein by weight.

10. The proteinaceous material of claim 8, wherein the denatured non-dairy isolated protein is egg albumin, pea protein isolate, soy protein isolate, or beef protein isolate and the solid fat is palm shortening.

11. A process for producing an edible proteinaceous material with a greater than 50% by weight protein concentration comprising the steps of:
a. pre-whipping a solid fat via shear stress mixing;
b. adding a protein isolate to the pre-whipped solid fat; while
c. simultaneously denaturing the protein isolate by continuing to shear stress mix the solid fat and protein isolate mixture; and
d. continuing to add protein isolate to the protein and fat mixture until the total weight of the mixture equals the initial weight of solid fat prior to whipping plus the desired weight of protein.

12. The process of claim 11, wherein the protein isolate is denatured through shear stress mixing using a high shear mixer employing an impeller-type head attachment.

13. The process of claim 11, wherein the protein isolate is a non-dairy isolated protein.

14. The process of claim 13, wherein the non-dairy isolated protein is added to the solid fat at a rate less than or equal to about 0.5% of the final desired weight of protein in the proteinaceous material per second.

15. The process of claim 14, wherein the proteinaceous material is greater than 50% but less than or equal to about 75% protein by weight.

16. The process of claim 14, wherein the proteinaceous material is greater than 50% but less than or equal to about 65% protein by weight.

17. The process of claim 14, wherein the proteinaceous material is about 60% to about 65% protein by weight.

18. The process of claim 14, wherein the non-dairy isolated protein is egg albumin, pea protein isolate, soy protein isolate, or beef protein isolate.

19. The process of claim 14, wherein the non-dairy isolated protein is egg albumin, pea protein isolate, soy protein isolate, or beef protein isolate and the solid fat is palm shortening, butter, margarine, soybean shortening, or hydrogenated olive oil.

20. The process of claim 14, wherein the non-dairy isolated protein is egg albumin, pea protein isolate, soy protein isolate, or beef protein isolate, the solid fat is palm shortening, butter, margarine, soybean shortening, or hydrogenated olive oil, and the proteinaceous material is about 60% to about 65% protein by weight.
